(19) United States
(12) Patent Application Publication
(10) Pub. No.: US 2002/0117139 A1
(43) Pub. Date: Aug. 29, 2002

(54) Air intake device for an internal combustion engine and methods for its operation

(76) Inventors: Jochen Linhart, Waiblingen (DE); Herbert Pietrowski, Pleidelsheim (DE); Matthias Teschner, Ludwigsburg (DE); Stephan Wild, Neuenbuerg (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/073,271

(22) Filed: Feb. 13, 2002

(30) Foreign Application Priority Data
Feb. 13, 2001 (DE) 101 06 515.9

(51) Int. Cl. F02M 35/10

(52) U.S. Cl. 123/184.55

(57) ABSTRACT

An intake device for an internal combustion engine including a performance channel (14) and a torque channel (17) for combustion air intake, which branch off from a plenum (12). The performance channel (14) can be closed in a known manner by a rotary valve (13). A solenoid valve (18) advantageously also is arranged in the torque channel (17) for rapidly opening and closing the torque channel. The solenoid valve advantageously can be used to close the torque channel completely in the so-called performance position. This makes it possible effectively to prevent a superposition of flow effects between the two channels and thereby to increase the performance of the internal combustion engine in the so-called performance position of the two valves. At the same time, the solenoid valve (18) can be used in a known manner as an air cycle valve.

### BACKGROUND OF THE INVENTION

This invention relates to an intake device for an internal combustion engine in which two intake channels per cylinder are provided, and one of the intake channels can be closed by a closing element. The invention further relates to various methods for operating this intake device in an internal combustion engine.

Intake devices of this type are known in the art. For example, Ohrnberger et al., U.S. Pat. No. 5,901,677 (=DE 43 44 504) discloses a so-called switching intake system, which is equipped with long and short intake channels for each cylinder. The short channels are referred to as performance channels and in normal operation of the internal combustion engine are closed by a common drum controller. Above a certain engine speed, the drum controller is opened, so that intake air flows through the short intake channels rather than through the long ones. This improves the charging behavior for the intake air of the internal combustion engine. At lower speed ranges of the internal combustion engine, the air flows through the longer intake channels, referred to as torque channels, which due to pipe resonances also result in improved charging of the internal combustion engine with intake air.

In so-called performance switching, however, the intake behavior of the intake air in the intake manifold continues to be influenced to a certain degree by the long intake channels. This leads to a certain superimposition of difficult to predict pipe resonances, which has the effect of distorting the result.

### SUMMARY OF THE INVENTION

It is an object of the invention to provide an improved air intake device with multiple intake channels per engine cylinder.

It is also an object of the invention to provide an air intake device for an internal combustion engine in which the intake behavior and/or air charging performance can be optimally adapted to the current operating state of the internal combustion engine.

Another object of the invention is to provide a method of operating a multiple-channel air intake device for an internal combustion engine.

In accordance with a first aspect of the invention, the objects are achieved by providing an air intake device for an internal combustion engine with at least one cylinder, said device comprising an air plenum, a first intake channel for each cylinder which leads from said plenum to the respective cylinder, a first closing device for each said first intake channel for closing the respective first intake channel, a second intake channel for each cylinder which leads from said plenum to the respective cylinder, and a second closing device for each said second intake channel for closing the respective second intake channel.

In a second aspect of the invention, the objects are achieved by providing a method of operating an air intake device for an internal combustion engine with at least one cylinder, said intake device comprising an air plenum, a first intake channel for each cylinder which leads from said plenum to the respective cylinder, a first closing device for each said first intake channel for closing the respective first intake channel, a second intake channel for each cylinder which leads from said plenum to the respective cylinder, and a second closing device for each said second intake channel for closing the respective second intake channel;

said method comprising closing each first closing device and cyclically opening and closing each second closing device in coordination with an intake valve of the cylinder of the internal combustion engine to which the respective first and second channels lead, in order to achieve optimal filling of the respective cylinder with intake air for the current operating state of the internal combustion engine, or

the second intake channel leading to each cylinder being longer than the first intake channel leading to the respective cylinder, and said method comprising opening each first closing device and closing each second closing device when the internal combustion engine exceeds a set speed, or

said method comprising simultaneously opening the first and second closing devices for each respective cylinder.

The intake device of the present invention is provided in a known manner with two intake channels per cylinder. The term intake device should be understood in its broad sense as a duct structure that facilitates the aspiration of combustion air into the engine cylinders. This duct structure can be formed by various functional components. In each of the first intake channels leading to the cylinders a closing device is arranged. The invention is characterized in that in each of the second intake channels a second closing device is arranged so that these channels can also be closed. This has the enormous advantage that optimal switching with respect to the charging of the cylinders with combustion air can always be effected by a suitable interplay of the respective closing devices. Various operating parameters of the internal combustion engine may be taken into account, especially the instantaneous speed of the engine. Engine speed is of prime importance for the generation of air vibrations within the intake channels, so that the effect of what is referred to as resonance pipe charging of the cylinders can be utilized by appropriate switching of the closing devices. A further possibility is the cyclic switching of the closing devices. This is particularly important for the second closing devices in the second intake channels. Cycling is effected in interplay with the intake valves of the cylinders, so that a specific elevated pressure can be built up within the intake channels, which improves the filling of the cylinders.

To utilize the described effects, various methods may be used to operate the internal combustion engine. These methods will be described in greater detail hereinafter.

In one advantageous embodiment of the invention, the respective second intake channels are longer than the first. This makes it possible to use the above-described effect of resonance pipe charging particularly efficiently through the second intake channels. The length of these intake channels is necessary because resonance pipe charging is intended to be used at lower rotational speeds of the internal combustion engine. These lower speeds result in lower resonance frequencies, which can be produced only with intake channels having a certain length.

In a further advantageous embodiment of the invention, the first intake channels have a larger cross section than the second ones. Accordingly, the first intake channels are not intended to use the effects of resonance pipe charging. So-called performance switching, which can be produced with these short channels, is intended to provide the least possible resistance to the intake airflow. This resistance can be reduced if the channels are as short as possible and have a large cross section.

It is furthermore advantageous to combine different functional components in an intake manifold. Accordingly, this intake manifold comprises the plenum and the first and second intake channels. In addition, the various closing devices can be arranged in the intake manifold. This results in a component that lends itself extremely well to being pre-assembled. This provides savings in the cost-sensitive area of final assembly of the internal combustion engine.

Another advantageous option is to integrate the second closing device into the cylinder head of the internal combustion engine. This second closing device can be configured, for example, as a solenoid valve, and to that extent has a certain relationship to the intake valve on the cylinder. A piezoelectric valve, for instance, may also be used instead of a solenoid valve.

In accordance with another advantageous embodiment of the invention, a rotary valve is used for the first closing device. This rotary valve may also be constructed as a drum controller, which simultaneously closes or opens some or all of the first intake channels.

One method of operating the intake device according to the invention provides that the first closing device is closed, and the second closing device is cyclically operated together with the associated intake valve. This makes it possible to achieve optimal filling of each cylinder with intake air by appropriate switching of the valves in the operating ranges where the performance channel should be closed. Known control methods disclosed, for instance, in published German patent application no. DE 197 54 287, may be used for this purpose. In such a case the first valves operate according to the principle of so-called air cycle valves.

An alternative operating mode of the intake device according to the invention is suitable for other operating states of the internal combustion engine. This mode requires that the second intake channel be configured as a resonance pipe. When a predetermined speed is exceeded at which the effect of resonance pipe charging can no longer be satisfactorily used due to the geometric ratios of the intake manifold, the second intake channel is closed. Instead, the performance channel is opened so that the air can flow only through the latter. This makes it possible to completely exclude any superimposition of vibrations from the respective second channel. The air can flow undisturbed through the performance channel, the cross-section of which must be designed accordingly. This makes it possible to optimize the operation of the internal combustion engine in so-called performance switching.

A modification of the described method can be achieved by opening the first and the second closing devices simultaneously. In this case, the intake cross section available for combustion air intake can be expanded still further. This can be understood as complementary to the above-described performance switching and again produces flow conditions that correspond to the intake manifold disclosed in Ohrnberger et al., U.S. Pat. no. 5,901,677 in performance switching.

This illustrates that optimal switching for each operating state may be established through a suitable interplay between the first and the second closing devices. It is not excluded that prior art switching states of the internal combustion engine may be used in certain operating conditions. The inventive intake device, however, assures a combination of these prior art switching states, so that optimum conditions can be established in every operating state of the internal combustion engine. At the same time, the intake device according to the invention also permits switching states that have not previously been possible in the intake manifold designs of the prior art.

These and other features of preferred embodiments of the invention, in addition to being set forth in the claims, are also disclosed in the specification and/or the drawings, and the individual features each may be implemented in embodiments of the invention either alone or in the form of subcombinations of two or more features and can be applied to other fields of use and may constitute advantageous, separately protectable constructions for which protection is also claimed.

### BRIEF DESCRIPTION OF THE DRAWINGS

The invention will be described in further detail hereinafter with reference to illustrative preferred embodiments shown in the accompanying drawings in which:

FIG. 1 is a schematic cross section of an intake manifold with closing devices in the performance channel as well as in the torque channel;

FIG. 2 shows the intake manifold according to FIG. 1 in a different switching state;

FIG. 3 is a schematic cross-sectional illustration of the integration of the second valve in the cylinder head, and FIG. 4 shows the switching possibilities for an air cycle valve.

### DETAILED DESCRIPTION OF PREFERRED EMBODIMENTS

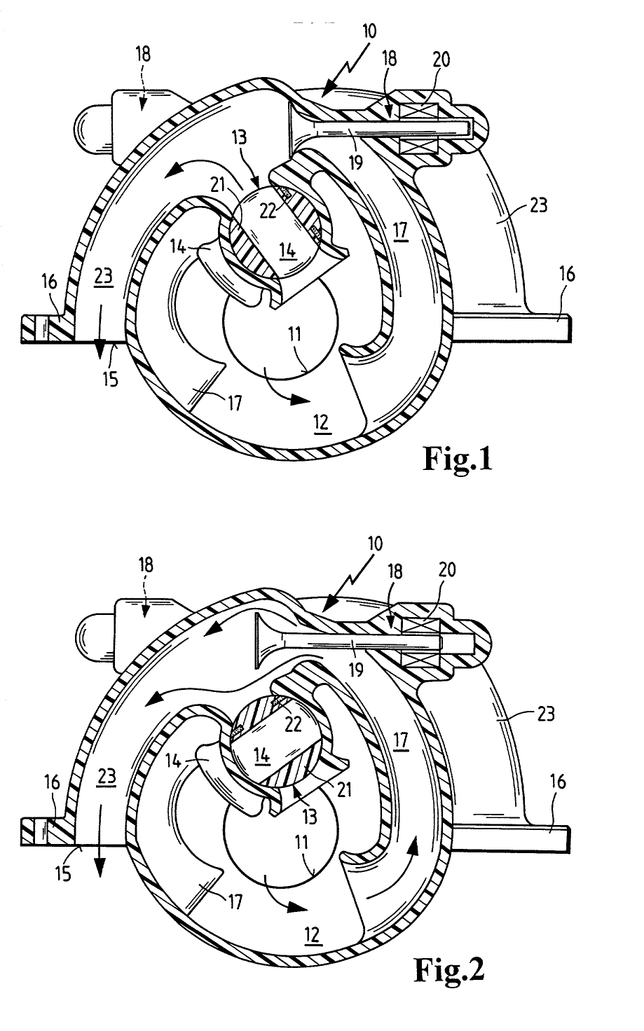

FIG. 1 shows an intake manifold 10 for an internal combustion engine (not shown) with a V-shaped arrangement of the cylinders. As indicated by the arrows, the combustion air enters through inlet 11 into a plenum 12 of the intake manifold and, if the rotary valve 13 is open, traverses a first intake channel 14 and thus reaches a cylinder-side outlet 15, which is integrated into a cylinder head flange 16 for mounting the intake manifold to the internal combustion engine (not shown).

Furthermore, a second intake channel 17 is arranged in plenum 12. This second intake channel is closed by a solenoid valve 18 indicated by a valve tappet 19 and a magnet coil 20. The second intake channel is longer and has a smaller cross section than the first intake channel. As a result, the first intake channel acts as a performance channel, and the second intake channel as a torque channel. In the operating state depicted in FIG. 1, the performance channel is open. This operating state is provided for high speeds of the internal combustion engine or an increased air requirement of the internal combustion engine. The short path of the intake channel keeps air resistance low. The large cross section of the performance channel results in little pressure loss even with an increased air requirement. In contrast to the valve position depicted in FIG. 1, the solenoid valve 18 can also be opened. This further reduces the flow resistance for the intake air. The closed position shown, however, has the advantage of a particularly unperturbed airflow through the first intake channel 14, since influences of the second intake channel can be excluded.

FIG. 2 shows another operating state of the intake manifold as it is preferably used for low engine rotational speeds. Here, the solenoid valve 18 is open and the rotary valve 13 is closed. The rotary valve 13 is comprised of a roller body 21, which is fitted into the first intake channel 14 in a form-fit design. A molded plastic seal 22 ensures a tight seal of the first intake channel 14. The solenoid valve functions in association with an intake valve on the cylinder of the internal combustion engine (not shown). When the valve is open, the intake air flows around the valve tappet 19. Using the solenoid valve makes it possible to achieve extremely short switching times. In the operating state depicted in FIG. 2, this allows the use of the solenoid valve 18 as an air cycle valve (cf. also the description to FIG. 4).

The intake manifold according to FIGS. 1 and 2 is cut in a plane showing the plenum 12 and the intake channels 14, 17, which wind around the plenum in a spiral and lead to one of the cylinder banks of the internal combustion engine (not shown). Behind the drawing plane, other intake channels 14, 17 leading to the other cylinder bank of the internal combustion engine may be seen in the plenum. Also shown are common segments 23 of the intake channels, in which the respective first intake channels 14 and second intake channels 17 open.

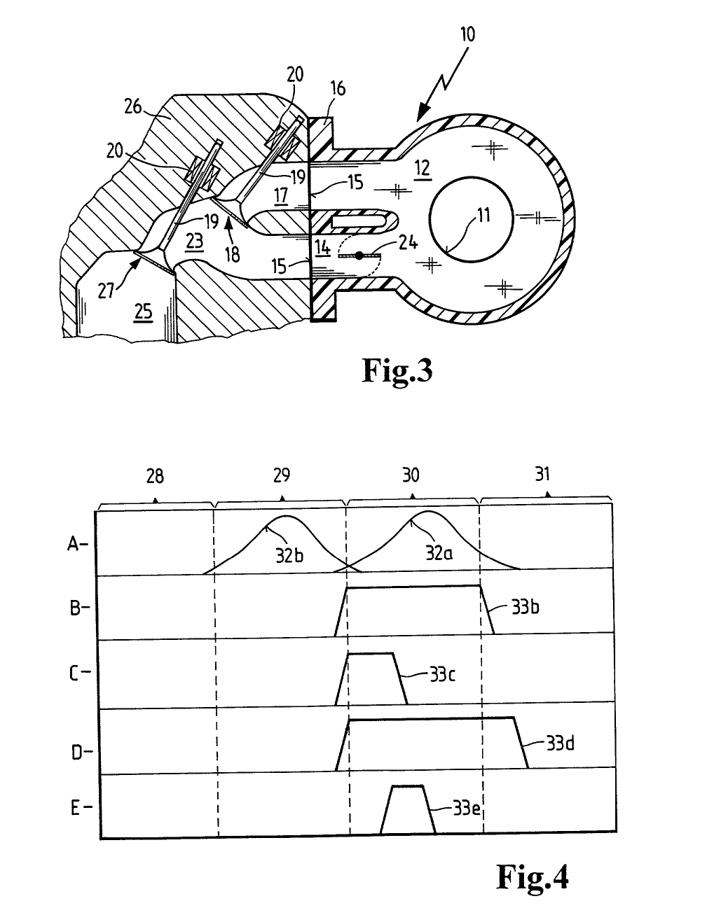

FIG. 3 schematically shows an intake manifold 10 having first and second intake channels 14, 17 extending in parallel. This arrangement is preferably used to achieve selective channel disabling with the aid of a control flap 24. This control flap 24 can also be used to impart a desired turbulence to the intake air which leads to improved filling of the cylinder 25.

The intake manifold 10 is flange-mounted to a schematically depicted cylinder head 26 of the internal combustion engine by a cylinder head flange 16. The cylinder head also contains the previously mentioned solenoid valve 18 for closing the second intake channel 17. This clearly illustrates how in any embodiment of the invention, the intake channels within the scope of the invention may be formed by a combination of the intake manifold 10 and the cylinder head 26.

When control flap 24 is closed, valve 18 can be used as an air cycle valve. Furthermore, the valve can be optionally and selectively used to close one of the two intake channels 14, 17. The channel providing more favorable flow conditions and better fuel distribution in the current state of the combustion engine is selected. Both intake channels 14 and 17 lead through common segment 23 to an intake valve 27, which is constructed similarly to the solenoid valve 18.

FIG. 4 illustrates possible methods, which are known in the art, for switching the solenoid valve 18 as an air cycle valve. The columns represent the cycles of the four-cycle engine, i.e., expansion 28, exhaust 29, intake 30, and compression 31. Line A shows the valve lift (opening) 32a of the intake valve and the valve lift 32b of the exhaust valve.

Lines B to E show the possible opening of the solenoid valve 18. Switching should be as rapid as possible, and the inclined leading and trailing edges of the curves as shown should result from the switching time of the solenoid valve.

Line B shows valve actuation 33b at full engine load. In this case it is desirable for the valve opening to overlap with the valve lift of the intake valve 32a. This operating state, however, can be replaced completely with the opening of the first channel in the intake manifold according to FIG. 1 and 2, since an optimum intake result in this illustrative embodiment is achieved by the described performance channel.

In line C, valve actuation 33c is provided for operation of the internal combustion engine in the partial load range and is referred to as early intake closing (EIC). This mode of operation may be considered a supplement to reach an optimum intake result in the described exemplary embodiments.

Line D shows valve actuation 33d, which is referred to as late intake closing (LIC). Finally, line E with valve actuation 33e represents the possibility of a late intake opening (LIO) and early intake closing (EIC).

The exact switching points in the corresponding operating states of the internal combustion engine are a function of the conditions in the intake path and the internal combustion engine and must be determined in each individual case by means of suitable tests. By combining the described measures it is possible to adjust an optimal filling behavior for the internal combustion engine in all the operating states of the engine. As a result, the available combustion space can be optimally used and the emission values of the engine can be simultaneously improved.

The foregoing description and examples have been set forth merely to illustrate the invention and are not intended to be limiting. Since modifications of the described embodiments incorporating the spirit and substance of the invention may occur to persons skilled in the art, the invention should be construed broadly to include all variations falling within the scope of the appended claims and equivalents thereof.

What is claimed is:

1. An intake device for an internal combustion engine with at least one cylinder, said device comprising:
an air plenum
a first intake channel for each cylinder which leads from said plenum to the respective cylinder;
for each said first intake channel, a first closing device for closing the respective first intake channel;
a second intake channel for each cylinder which leads from said plenum to the respective cylinder, and
for each said second intake channel, a second closing device for closing the respective second intake channel.

2. An intake device according to claim 1, wherein the second intake channel leading to each cylinder is longer than the first intake channel leading to the respective cylinder.

3. An intake device according to claim 2, wherein the first intake channel leading to each cylinder has a larger cross section than the second intake channel leading to the respective cylinder.

4. An intake device according to claim 1, wherein said intake device comprises an intake manifold module which includes the plenum, said first and second intake channels up to a junction with a cylinder head of the internal combustion engine, and said first and second closing devices.

5. An intake device according to claim 1, wherein each second closing device is integrated into a cylinder head of the internal combustion engine.

6. An intake device according to claim 1, wherein each first closing device comprises a rotary valve.

7. An intake device according to claim 1, wherein each second closing device comprises a solenoid valve.

8. A method of operating an air intake device for an internal combustion engine with at least one cylinder, said intake device comprising an air plenum, a first intake channel for each cylinder which leads from said plenum to the respective cylinder, a first closing device for each said first intake channel for closing the respective first intake channel, a second intake channel for each cylinder which leads from said plenum to the respective cylinder, and a second closing device for each said second intake channel for closing the respective second intake channel;
said method comprising closing each first closing device and cyclically opening and closing each second closing device in coordination with an intake valve of the cylinder of the internal combustion engine to which the respective first and second channels lead, in order to achieve optimal filling of the respective cylinder with intake air for the current operating state of the internal combustion engine.

9. A method of operating an air intake device for an internal combustion engine having at least one cylinder, said intake device comprising an air plenum, a first intake channel for each cylinder which leads from said plenum to the respective cylinder, a first closing device for each said first intake channel for closing the respective first intake channel, a second intake channel for each cylinder which leads from said plenum to the respective cylinder, and a second closing device for each said second intake channel for closing the respective second intake channel, the second intake channel leading to each cylinder being longer than the first intake channel leading to the respective cylinder;
said method comprising opening each first closing device and closing each second closing device when the internal combustion engine exceeds a set speed.

10. A method of operating an air intake device for an internal combustion engine having at least one cylinder, said intake device comprising an air plenum, a first intake channel for each cylinder which leads from said plenum to the respective cylinder, a first closing device for each said first intake channel for closing the respective first intake channel, a second intake channel for each cylinder which leads from said plenum to the respective cylinder, and a second closing device for each said second intake channel for closing the respective second intake channel;
said method comprising simultaneously opening the first and second closing devices for each respective cylinder.
